(19) United States
(12) Patent Application Publication
(10) Pub. No.: US 2020/0167215 A1
(43) Pub. Date: May 28, 2020

(54) Method and System for Implementing an Application Programming Interface Automation Platform

(71) Applicant: CenturyLink Intellectual Property LLC, Broomfield, CO (US)

(72) Inventor: Gurpreet Singh Sidhu, Aurora, CO (US)

(21) Appl. No.: 16/366,957

(22) Filed: Mar. 27, 2019

Related U.S. Application Data
(60) Provisional application No. 62/772,444, filed on Nov. 28, 2018.

(51) Int. Cl. G06F 9/54; H04L 29/08; H04L 29/06

(52) U.S. Cl. CPC G06F 9/547; G06F 9/541; H04L 67/40; H04L 67/327; H04L 67/20

(57) ABSTRACT

Novel tools and techniques are provided for implementing an automation platform for an application programming interface, and, more particularly, to methods, systems, and apparatuses for implementing an automation platform for designing, building, and executing application programming interfaces. In an embodiment, a computing system might receive a request to set up an application programming interface (“API”) in communication with a first application and at least one second application; and might receive one or more first input parameters associated with the first application. The computing system might autonomously generate the API in communication with the first application and each of the at least one second application, based at least in part on the one or more first input parameters associated with the first application.

### CROSS-REFERENCES TO RELATED APPLICATIONS

This application claims priority to U.S. patent application Ser. No. 62/772,444 (the “'444 application”), filed Nov. 28, 2018 by Gurpreet Singh Sidhu (attorney docket no. 1519-US-P1), entitled, “Method and System for Implementing an Application Programming Interface Automation Platform,” the disclosure of which is incorporated herein by reference in its entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to methods, systems, and apparatuses for implementing an automation platform for an application programming interface, and, more particularly, to methods, systems, and apparatuses for implementing an automation platform for designing, building, and executing application programming interfaces.

### BACKGROUND

Traditionally, in order to create an application programming interface (“API”) for one or more applications, programmers have to develop code for each API that needs to be created. Developing code for each API can be time consuming, requiring hours upon hours of testing, compiling, and/or executing time. Further, each time an API is developed, coding issues, software “bugs,” vulnerabilities, coding errors, or other errors, or the like, may occur.

Hence, there is a need for more robust and scalable solutions for implementing an automation platform for an application programming interface, and, more particularly, to methods, systems, and apparatuses for implementing an automation platform for designing, building, and executing application programming interfaces.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a schematic diagram illustrating a system for implementing an automation platform for designing, building, and executing application programming interfaces, in accordance with various embodiments.

FIGS. 2A and 2B are schematic diagrams illustrating examples of automation platforms for designing, building, and executing application programming interfaces, in accordance with various embodiments.

FIG. 3 is a schematic diagram illustrating an example of an application programming interface generated by an automation platform, in accordance with various embodiments.

FIGS. 4A and 4B are flow diagrams illustrating a method for implementing an automation platform for designing, building, and executing application programming interfaces, in accordance with various embodiments.

FIG. 5 is a block diagram illustrating an exemplary computer or system hardware architecture, in accordance with various embodiments.

FIG. 6 is a block diagram illustrating a networked system of computers, computing systems, or system hardware architecture, which can be used in accordance with various embodiments.

### DETAILED DESCRIPTION OF CERTAIN EMBODIMENTS

### Overview

Various embodiments provide tools and techniques for implementing an automation platform for an application programming interface, and, more particularly, to methods, systems, and apparatuses for implementing an automation platform for designing, building, and executing application programming interfaces.

In various embodiments, a computing system might receive from a user a request to set up an application programming interface (“API”) in communication with a first application and at least one second application. In some embodiments, the computing system might additionally receive one or more first input parameters associated with the first application. According to some embodiments, the computing system might autonomously generate the API in communication with the first application and each of the at least one second application, based at least in part on the one or more first input parameters associated with the first application.

The various embodiments provide advantages over conventional development of APIs in that by using the automation platform for designing, building, and executing APIs in accordance with the various embodiments, one or more APIs may be effectively and efficiently implemented between one or more applications. The advantages of such an automation platform include providing tools to application developers to integrate their application within a network without having to separately develop the API and generating one or more APIs that are compatible with one or more different applications. Thus, the automation platform may be used to autonomously generate code to develop the API, set up communications paths between one or more applications via the API, provision cloud computing space to the API and/or one or more applications, provision or develop microservices for the API and/or one or more applications, provide metrics and analytics associated with the API and/or one or more applications, and/or provide security for the API and/or one or more applications, and/or the like. In this manner, API development may be performed in a significantly shorter time compared with traditional API development techniques—from hours to minutes.

These and other features and advantages of the various embodiments are described in detail below with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

Various embodiments described herein, while embodying (in some cases) software products, computer-performed methods, and/or computer systems, represent tangible, concrete improvements to existing technological areas, including, without limitation, API generation technology, application technology, application integration technology, networking technology, communication technology, and/or the like. In other aspects, certain embodiments, can improve the functioning of user equipment or systems themselves (e.g., API generation systems, application systems, application integrations systems, networking systems, communication systems, etc.), for example, by autonomously generating, with the computing system, the API in communication with the first application and each of the at least one second application, based at least in part on the one or more first input parameters associated with the first application; and/or the like. In particular, to the extent any abstract concepts are present in the various embodiments, those concepts can be implemented as described herein by devices, software, systems, and methods that involve specific novel functionality (e.g., steps or operations), such as, autonomously generating, with the computing system, the API in communication with the first application and each of the at least one second application, based at least in part on the one or more first input parameters associated with the first application, and/or the like, to name a few examples, that extend beyond mere conventional computer processing operations. These functionalities can produce tangible results outside of the implementing computer system, including, merely by way of example, optimized and efficient integration of applications within a network, automatic generation of application programming interfaces, and/or the like.

In an aspect, a method might comprise receiving, with a computing system, a request to set up an application programming interface (“API”) in communication with a first application and at least one second application; and receiving, with the computing system, one or more first input parameters associated with the first application. The method might further comprise autonomously generating, with the computing system, the API in communication with the first application and each of the at least one second application, based at least in part on the one or more first input parameters associated with the first application.

In some embodiments, autonomously generating, with the computing system, the API in communication with the first application and each of the at least one second application might comprise at least one of: (1) autonomously generating, with the computing system, code to implement the API in communication with the first application and each of the at least one second application; (2) autonomously generating, with the computing system, one or more communications paths between the first application and each of the at least one second application via the API; (3) autonomously provisioning, with the computing system, cloud computing space to at least one of the first application, one or more of the at least one second application, or the API; (4) autonomously provisioning, with the computing system, one or more microservices to at least one of the first application or one or more of the at least one second application, via the API; (5) autonomously generating, with the computing system, performance monitoring between the first application and each of the at least one second application via the API; and/or (6) autonomously generating, with the computing system, secure access to the at least one of the first application, each of the at least one second application, or the API; and/or the like.

According to some embodiments, the one or more microservices that are provisioned might include, without limitation, at least one of one or more management microservices, one or more security microservices, one or more streaming microservices, one or more bill payment microservices, or one or more customer microservices, and/or the like.

In some cases, the first application may be associated with a customer of a service provider network and each of the at least one second application may be associated with the service provider. Alternatively, the first application may be associated with a service provider network and each of the at least one second application may be associated with a customer of the service provider.

In some instances, the method might further comprise receiving, with the computing system, one or more second input parameters associated with each of the at least one second application; and autonomously generating, with the computing system, the API in communication with the first application and each of the at least one second application, based at least in part on the one or more first input parameters associated with the first application and based at least in part on the one or more second input parameters associated with each of the at least one second application.

In some embodiments, the one or more first input parameters and the one or more second input parameters might comprise at least one of one or more programming languages associated with the at least one of the first application, each of the at least one second application, or the API; one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API; and/or the like.

In some cases, the method might further include receiving, with the computing system, one or more third input parameters associated with the API; and autonomously generating, with the computing system, the API in communication with the first application and each of the at least one second application, based at least in part on the one or more first input parameters associated with the first application and based at least in part on the one or more third input parameters associated with the API.

In various instances, the one or more third input parameters might comprise at least one of one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API; and/or the like.

In another aspect, an apparatus might comprise at least one processor and a non-transitory computer readable medium communicatively coupled to the at least one processor. The non-transitory computer readable medium might have stored thereon computer software comprising a set of instructions that, when executed by the at least one processor, causes the apparatus to: receive a request to set up an application programming interface (“API”) in communication with a first application and at least one second application; receive one or more first input parameters associated with the first application; and autonomously generate the API in communication with the first application and each of the at least one second application, based at least in part on the one or more first input parameters associated with the first application.

In some embodiments, the one or more first input parameters might comprise at least one of one or more programming languages associated with the at least one of the first application, each of the at least one second application, or the API; one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API; and/or the like.

According to some embodiments, autonomously generating the API in communication with the first application and each of the at least one second application might comprise at least one of: (1) autonomously generating code to implement the API in communication with the first application and each of the at least one second application; (2) autonomously generating one or more communications paths between the first application and each of the at least one second application via the API; (3) autonomously provisioning cloud computing space to at least one of the first application, one or more of the at least one second application, or the API; (4) autonomously provisioning one or more microservices to at least one of the first application or one or more of the at least one second application, via the API; (5) autonomously generating performance monitoring between the first application and each of the at least one second application via the API; and/or (6) autonomously generating secure access to the at least one of the first application, each of the at least one second application, or the API; and/or the like.

In yet another aspect, a system might comprise a computing system. The computing system might comprise at least one first processor and a first non-transitory computer readable medium communicatively coupled to the at least one first processor. The first non-transitory computer readable medium might have stored thereon computer software comprising a first set of instructions that, when executed by the at least one first processor, causes the computing system to: receive a request to set up an application programming interface (“API”) in communication with a first application and at least one second application; receive one or more first input parameters associated with the first application; and autonomously generate the API in communication with the first application and each of the at least one second application, based at least in part on the one or more first input parameters associated with the first application.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### Specific Exemplary Embodiments

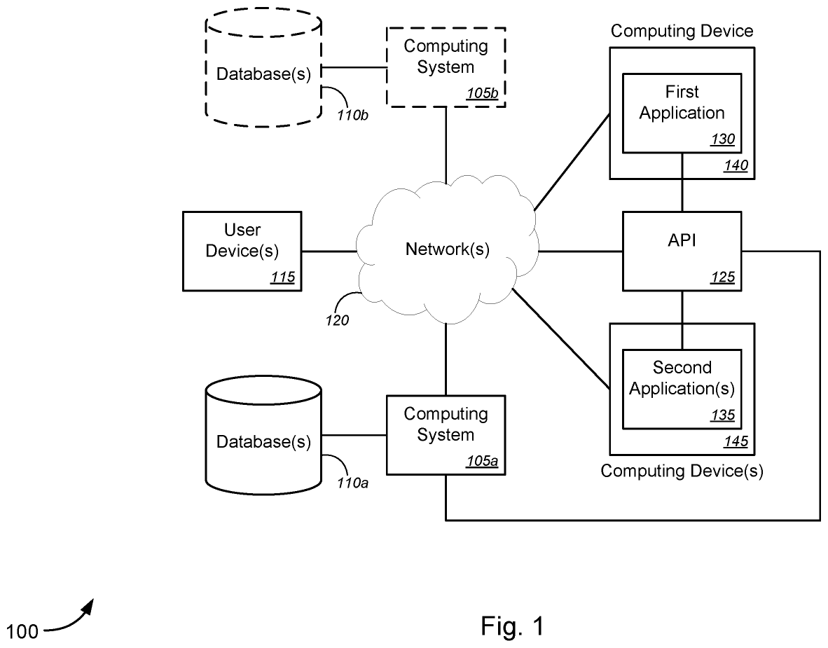

We now turn to the embodiments as illustrated by the drawings. FIGS. 1-6 illustrate some of the features of the method, system, and apparatus for implementing an automation platform for an application programming interface, and, more particularly, to methods, systems, and apparatuses for implementing an automation platform for designing, building, and executing application programming interfaces, as referred to above. The methods, systems, and apparatuses illustrated by FIGS. 1-6 refer to examples of different embodiments that include various components and steps, which can be considered alternatives or which can be used in conjunction with one another in the various embodiments. The description of the illustrated methods, systems, and apparatuses shown in FIGS. 1-6 is provided for purposes of illustration and should not be considered to limit the scope of the different embodiments.

With reference to the figures, FIG. 1 is a schematic diagram illustrating a system 100 for implementing an automation platform for designing, building, and executing application programming interfaces (“APIs”), in accordance with various embodiments.

In the non-limiting embodiment of FIG. 1, system 100 might comprise a computing system 105a and corresponding database(s) 110a. Alternatively, computing system 105a might be a remote computing system 105b with corresponding database(s) 110b. System 100 might further comprise one or more user devices 115. In some cases, the one or more user devices 115 might be local to the computing system 105a and corresponding database(s) 110a.

In some embodiments, the computing system 105 (either computing system 105a or remote computing system 105b, or both) might include, without limitation, one of an API generator, an automation platform for generating APIs, a processor of a user device, a server computer, a server computer over a network, a cloud-based computing system over a network, or a distributed computing system, and/or the like. A user device 115 among the one or more user devices 115 might include, without limitation, at least one of a laptop computer, a tablet computer, a smart phone, a mobile phone, a personal digital assistant, a remote-control device, or a portable gaming device, and/or the like.

System 100 might further include an API 125 providing at least one of connectivity, routines, tools, communication protocols, and/or the like between a first application 130 and at least one second application 135. The first application 130 might run on a first computing device 140, while the at least one second application 135 might run on corresponding at least one second computing device 145. The computing system 105 might communicatively couple with each of the first computing device 140 and each of the at least one second computing device 145, via network(s) 120. Alternatively, API 125 may be distributed throughout network 120, hosted on a device comprising the first application 130 and/or the second application(s) 135, and/or the like.

In some cases, the first application 130 may be associated with a customer of a service provider network and each of the at least one second application 135 may be associated with the service provider network. Alternatively, the first application 130 may be associated with a service provider network and each of the at least one second application 135 may be associated with a customer of the service provider network. Alternatively, the first application 130 and the at least one second application 135 might both be associated with a service provider network or a customer of the service provider operating the service provider network.

In operation, a request to set up an application programming interface (“API”) 125 in communication with the first application 130 and the at least one second application 135 might be received by computing system 105a and/or computing system 105b. The request might be received automatically or autonomously from computing system 105, via user input into computing system 105, automatically or autonomously from the one or more user devices 115, via user input into the one or more user devices 115, or from a source via network(s) 120.

In some embodiments, computing system 105 might further receive one or more first input parameters associated with the first application 130. The one or more first input parameters might be received via user input into computing system 105, from the one or more user devices 115, or from a source via network(s) 120. Additionally and/or alternatively, the computing system 105 and/or user devices 115 might automatically determine one or more input parameters associated with the first application 130 needed to build API 125. In other words, computing system 105, user devices 115, and/or a user might provide the first application 130 to the computing system 105, and the computing system 105 might automatically or autonomously determine one or more input parameters associated with the first application 130 needed to build API 125.

The one or more first input parameters may not only be associated with the first application 130, the one or more first input parameters may also be associated with at least one of the at least one second application 135 and/or API 125. Additionally and/or alternatively, the one or more first input parameters may be associated with some combination of the first application 130, the at least one second application 135, and/or the API 125, and/or the like.

Based in part on the one or more input parameters entered by the user and/or user devices 115 and/or determined automatically by the computing system 105, computing system 105 may then automatically generate the API 125 in communication with the first application 130 and each of the at least one second application 135. Computing system 105 might access databases 110a and/or 110b for one or more rules, protocols, programming code, and/or the like to generate the API 125.

In some instances, autonomously generating, with the computing system 105, the API 125 in communication with the first application 130 and each of the at least one second application 135 might include at least one of: (1) autonomously generating, with the computing system 105, code to implement the API 125 in communication with the first application and each of the at least one second application; (2) autonomously generating, with the computing system 105, one or more communications paths between the first application 130 and each of the at least one second application 135 via the API 125; (3) autonomously provisioning, with the computing system 105, cloud computing space to at least one of the first application 130, one or more of the at least one second application 135, or the API 125; (4) autonomously provisioning, with the computing system 105, one or more microservices to at least one of the first application 130 or one or more of the at least one second application 135, via the API 125; (5) autonomously generating, with the computing system 105, performance monitoring between the first application 130 and each of the at least one second application 135 via the API 125; (6) autonomously generating, with the computing system 105, secure access to the at least one of the first application 130, each of the at least one second application 135, or the API 125; (7) autonomously generating, with the computing system 105, API management and cataloging, and/or (8) autonomously determining, with the computing system 105, one or more computers to host the first application 130, the at least one second application 135, and/or the API 125; and/or the like.

In some cases, the computing system 105 might further receive one or more second input parameters associated with the at least one second application 135 and/or with API 125. These second input parameters may be entered by a user, by a user device 115, and/or determined automatically by the computing system 105. The computing system 105 may then autonomously generate the API 125 based at least in part on the one or more first input parameters associated with the first application 130 and based at least in part on the one or more second input parameters associated with each of the at least one second application 135.

The one or more first input parameters and the one or more second input parameters may include, without limitation, at least one of one or more programming languages associated with the at least one of the first application 130, each of the at least one second application 135, or the API 125; one or more microservices associated with at least one of the first application 130, each of the at least one second application 135, or the API 125; cloud computing space associated with at least one of the first application 130, each of the at least one second application 135, or the API 125; performance metrics associated with at least one of the first application 130, each of the at least one second application 135, or the API 125; communication paths associated with at least one of the first application 130, each of the at least one second application 135, or the API 125; or security, authorization, or authentication associated with at least one of the first application 130, each of the at least one second application 135, or the API 125; and/or the like.

In general, the various embodiments provide advantages over conventional API generation in that by using the API generation platform in accordance with the various embodiments, APIs may be automatically generated to integrate one or more applications within a network without using significant time to program each individual API. Further, the API generation platform may be used to automatically make one or more applications compatible with different operating systems, programming languages, applications, and/or the like, without users having to program different APIs for each different operating system, programming language, application, and/or the like.

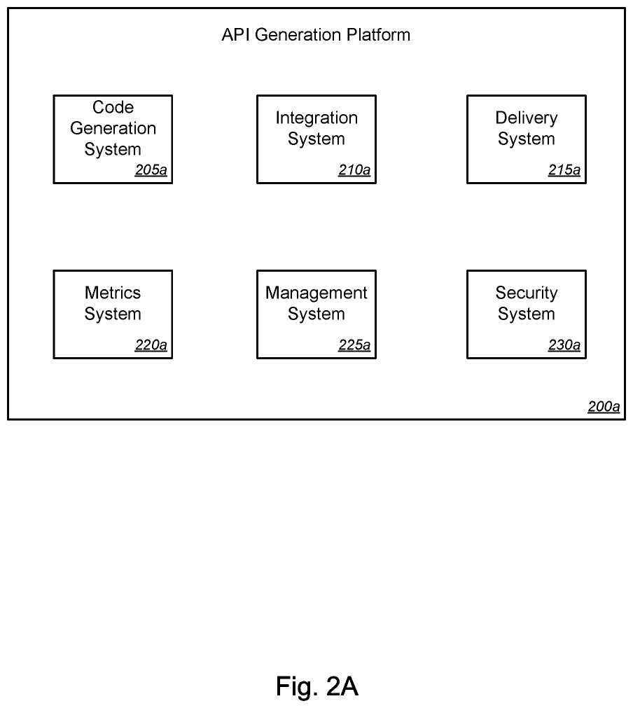

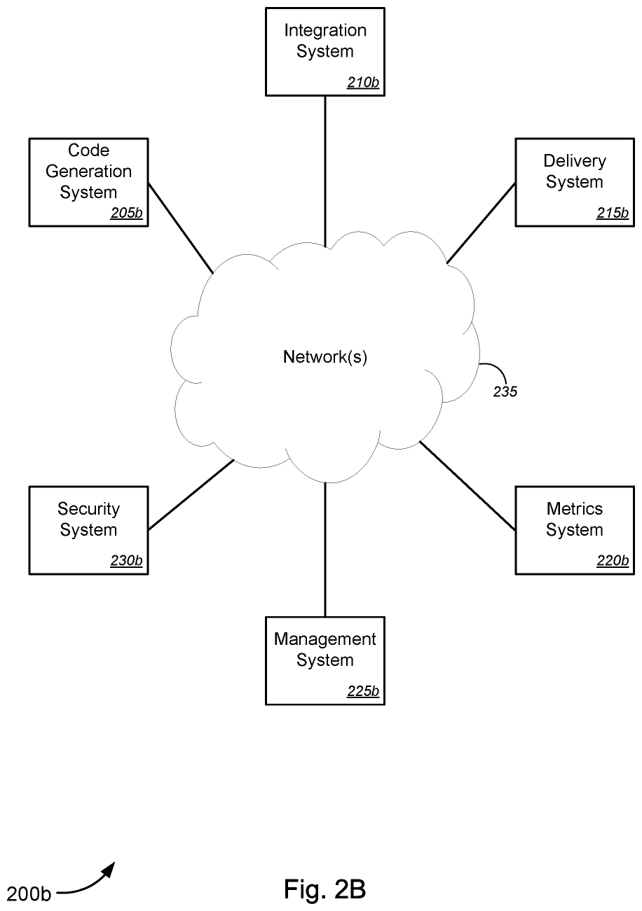

These and other aspects of the various embodiments are described in detail below with respect to FIGS. 2-4.

FIGS. 2A and 2B (collectively, “FIG. 2”) are schematic diagrams illustrating examples of automation platforms 200a and 200b (collectively, “automation platform 200” or the like) for designing, building, and executing application programming interfaces, in accordance with various embodiments. The automation platform 200a of FIG. 2A may be hosted on one computing system (e.g., computing system 105 of FIG. 1, or the like). Alternatively, the automation platform 200b might be distributed throughout a network 235 and hosted on one or more computing systems (e.g., computing systems 105a and 105b of FIG. 1).

The automation platform 200 might include a user interface configured to receive user input regarding a first application, at least one second application, and/or an API to communicatively couple the first application with the at least one second application. The user interface may be displayed on a user device (e.g., user device 115 of FIG. 1) and/or on a computing system (e.g., computing system 105 of FIG. 1).

The automation platforms 200a and/or 200b might further include, without limitation, one or more code generation systems 205a and/or 205b (collectively, “code generation systems 205” or the like), one or more integration systems 210a and/or 210b (collectively, “integration systems 210” or the like), one or more delivery systems 215a and/or 215b (collectively, “delivery systems 215” or the like), one or more metrics systems 220a and/or 220b (collectively, “metrics systems 220” or the like), one or more management systems 225a and/or 225b (collectively, “management systems 225” or the like), and/or one or more security systems 230a and/or 230b (collectively, “security systems 230” or the like), and/or the like.

In operation, the automation platform 200 might receive a request via the user interface to set up an application programming interface (“API”) in communication with a first application and at least one second application. Alternatively, the automation platform 200 might receive a request automatically from a user device and/or computing system to set up an application programming interface (“API”) in communication with a first application and at least one second application. The automation platform 200 might further receive one or more input parameters associated with the first application. The one or more input parameters may also be associated with the at least one second application and/or the API. The input parameters may be received through user input via the user interface and/or determined automatically by the automation platform 200 based on the first application specified in the request to set up the API.

The input parameters might include, without limitation, one of an indication of one or more programming languages associated with at least one of the first application, each of the at least one second application, or the API; one or more applications that need to be communicatively coupled to the first application via the API, one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API; and/or the like.

The automation platform 200 may then use the input parameters to automatically generate an API in communication with the first application and each of the at least one second application.

The code generation system 205 might be used to generate code and dependencies for one or more APIs. The code generation system 205 might use the input parameters and access a source code repository in a database to design, build, and execute an API. The code generated by the code generation system 205 may be used by one or more of integration system 210, delivery system 215, metrics system 220, management system 225, and/or security system 230, and/or the like. The code generation system 205 might further test or analyze code that is developed to ensure that the API is executing properly.

The integration system 210 might be used to integrate the API and/or one or more applications within a network or system based on the one or more input parameters. The integration system 210 might use the one or more input parameters to set up or generate one or more communications paths or pipelines between a first application and at least one second application via the API. The integration system 210 might further integrate the API, the first application, and/or the at least one second application with a service provider network, a customer network, and/or the like. The integration system 210 might also perform tests and/or analyze communications paths or pipelines to ensure that data is being shared between the first application and the at least one second application via the API.

Additionally and/or alternatively, the code generation system 205 and/or integration system 210 might be used to develop an API that is configured to communicatively couple and/or integrate a first application and at least one second application that use disparate programming/coding languages. These programming/coding languages may include at least one of Kubernetes, .NET, Java, and/or the like.

The delivery system 215 may provision cloud computing space for and/or microservices to at least one of the first application, each of the at least one second application, and/or the API, and/or the like, based on the one or more input parameters. The delivery system 215 may determine one or more computers to host the first application, each of the at least one second application, and/or the API, and/or the like. Additionally and/or alternatively, the delivery system 215 may be used to deploy one or more microservices via the communication paths and/or pipelines set up by the integration system 210. The one or more microservices might include, without limitation, at least one of one or more management microservices, one or more security microservices, one or more streaming microservices, one or more bill payment microservices, or one or more customer microservices, and/or the like.

The metrics system 220 may implement one or more performance metric monitoring systems that monitor performance metrics of at least one of the first application, each of the at least one second application, and/or the API, and/or the like, based on the one or more input parameters. The performance metrics that may be monitored may include, without limitation, at least one of response time, throughput, utilization of resources, availability of resources, bandwidth, transmission time, packet loss, channel capacity, power consumption, or latency, and/or the like. The performance metrics may be monitored by automation platform 200 to determine whether generated code, communications paths, and/or the like for the generated API were implemented correctly by the automation platform 200. Based on feedback from the performance metrics that the API is not functioning correctly, automation platform 200 may reconfigure at least some of the API. This step may be continued until the API communicatively coupled to the first application and the at least one second application is executing accurately. Alternatively, performance metrics feedback loops may be implemented as a permanent feature in order to ensure continued optimal operation of the API.

The API management system 225 might be used to set up management for the API and catalog the API based on the one or more input parameters. The API management system 225 may indicate one or more users and/or organizations that are authorized to utilize and/or modify the API that is generated.

The security system 230 of the automation platform 200 might implement security, authorization, and/or authentication for the API based on the one or more input parameters. The security system 230 might indicate users and/or organizations that are authorized to utilize and/or modify the API that is generated. Additionally and/or alternatively, security system 230 may set up systems that monitor at least one of the first application, each of the at least one second application, and/or the API for viruses or malware.

Although each of the one or more code generation systems 205, the one or more integration systems 210, the one or more delivery systems 215, the one or more metrics systems 220, the one or more management systems 225, and/or the one or more security systems 230, are described as separate functions, it should be noted that some or all of these functions may be combined into one singular automation platform 200. Alternatively, these functions, may be distributed throughout a network 235 as shown in FIG. 2B.

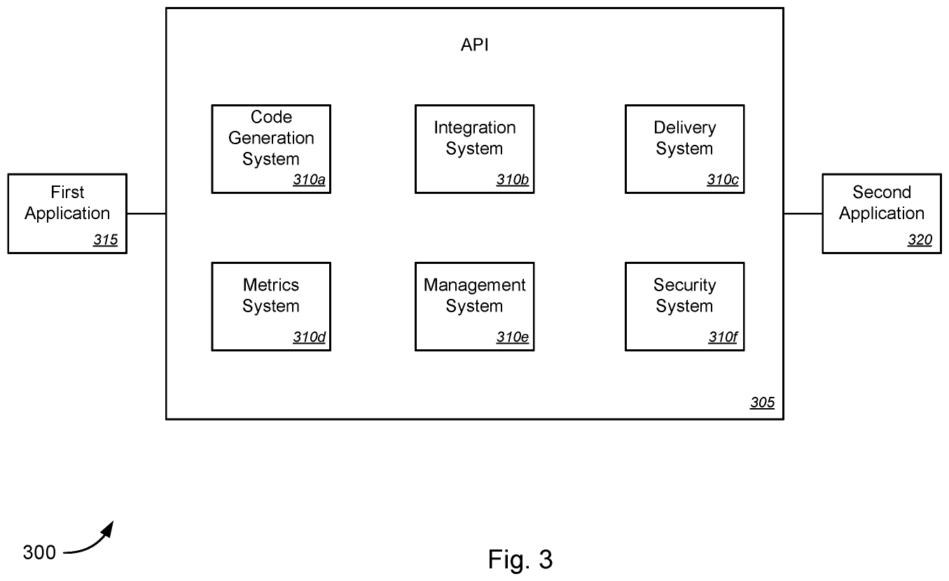

FIG. 3 is a schematic diagram illustrating an example 300 of an application programming interface (“API”) 305 generated by an automation platform (e.g., automation platform 200 of FIG. 2, or the like), in accordance with various embodiments.

The generated API 305 may be used to communicatively couple a first application 315 to a second application 320 and the first application 315 may communicate with the second application 320 via API 305.

The API 305 may be generated by the automation platform based on the one or more first input parameters. The generated API 305 may include at least one of code generation system 310a (generated by code generation system 205 of FIG. 2), integration services system 310b (generated by integration system 210 of FIG. 2), delivery services system 310c (generated by delivery system 215 of FIG. 2), metrics services system 310d (generated by metrics system 220 of FIG. 2), management services system 310e (generated by management system 225 of FIG. 2), and/or security services system 310f (generated by security system 230 of FIG. 2), and/or the like.

The code generation system 310a of the API 305 might include source code retrieved from a database (not shown in FIG. 3). The integration services system 310b might include communication pathways between the first application 315 and the at least one second application 320. The integration services system 310b might also include a testing or analysis function to test that data is being accurately shared between the first application 315 and the at least one second application 320 via the API 305. The delivery services system 310c might include provisioning storage and/or microservices to at least one of the first application 315 or each of the at least one second application 320 via the API 305. The metrics services system 310d might monitor performance metrics of at least one of the first application 315, each of the at least one second application 320, and/or the API 305, and/or the like. The management services system 310e might contain permissions indicating one or more users and/or organizations that are authorized to utilize and/or modify the API 305. The security services system 310f might include permissions indicating one or more users and/or organizations that are authorized to utilize and/or modify the API 305 and/or monitoring services that monitor at least one of the first application 315, each of the at least one second application 320, and/or the API 305 for viruses or malware, or the like.

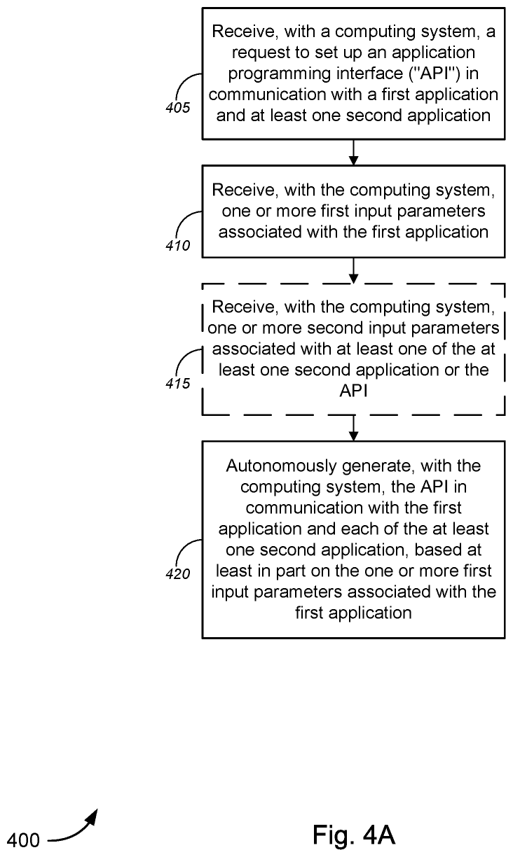

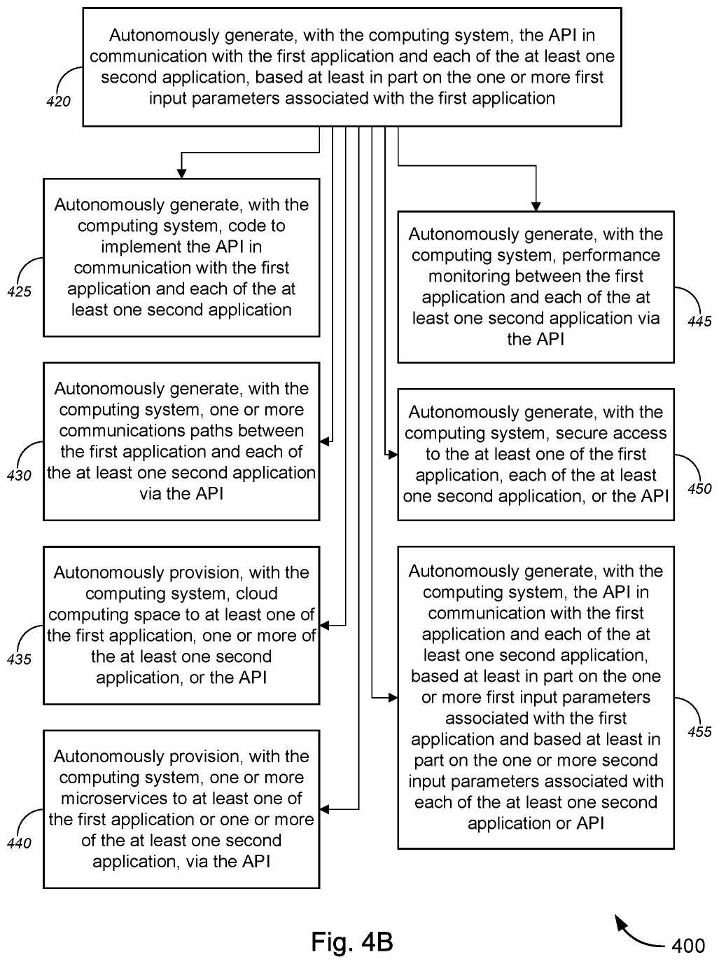

FIGS. 4A and 4B (collectively, “FIG. 4”) are flow diagrams illustrating a method 400 for implementing an automation platform for designing, building, and executing application programming interfaces, in accordance with various embodiments.

While the techniques and procedures are depicted and/or described in a certain order for purposes of illustration, it should be appreciated that certain procedures may be reordered and/or omitted within the scope of various embodiments. Moreover, while the method 400 illustrated by FIG. 4 can be implemented by or with (and, in some cases, are described below with respect to) the systems, examples, or embodiments 100, 200a, 200b, and 300 of FIGS. 1, 2A, 2B, and 3, respectively (or components thereof), such methods may also be implemented using any suitable hardware (or software) implementation. Similarly, while each of the systems, examples, or embodiments 100, 200a, 200b, and 300 of FIGS. 1, 2A, 2B, and 3, respectively (or components thereof), can operate according to the method 400 illustrated by FIG. 4 (e.g., by executing instructions embodied on a computer readable medium), the systems, examples, or embodiments 100, 200a, 200b, and 300 of FIGS. 1, 2A, 2B, and 3 can each also operate according to other modes of operation and/or perform other suitable procedures.

In the non-limiting embodiment of FIG. 4A, method 400, at block 405, might comprise receiving, with a computing system, a request to set up an application programming interface (“API”) in communication with a first application and at least one second application. The request may be received from a user attempting to integrate the first application into a network and/or automatically (or autonomously) from a computing system and/or a user device attempting to integrate the first application into a network.

In some embodiments, the computing system might include, without limitation, one of an API generator, an automation platform for generating an API, a processor of a user device running an app, a server computer over a network, a cloud-based computing system over a network, or a distributed computing system, and/or the like. In some instances, the applications might include, but are not limited to, at least one of an operating system, a computer game, a web application, a computer application, a phone application, a computer program, and/or the like.

At block 410, method 400 might comprise receiving, with the computing system, one or more first input parameters associated with the first application. In some cases, the computing system might receive one or more first input parameters from user input. Additionally and/or alternatively, the computing system may automatically or autonomously determine one or more input parameters based on the first application indicated in the request. Additionally and/or alternatively, the one or more first input parameters may be associated with each of the at least one second application and/or the API.

In some cases, the first application may be associated with a customer of a service provider network and each of the at least one second application may be associated with the service provider network. Alternatively, the first application may be associated with a service provider network and each of the at least one second application may be associated with a customer of the service provider network. The first application and the at least one second application may both be associated with a customer network or a service provider network.

At optional block 415, the method 400 might include receiving, with the computing system, one or more second input parameters associated with at least one of each of the at least one second application or the API.

In some embodiments, the one or more first input parameters and the one or more second input parameters might include, without limitation, at least one of one or more programming languages associated with the at least one of the first application, each of the at least one second application, or the API; one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API; and/or the like.

Method 400 might further comprise autonomously generating, with the computing system, the API in communication with the first application and each of the at least one second application, based at least in part on the one or more first input parameters associated with the first application (block 420).

With reference to FIG. 4B, autonomously generating, with the computing system, the API in communication with the first application and each of the at least one second application, based at least in part on the one or more first input parameters associated with the first application (at block 420) might include, without limitation, (1) autonomously generating, with the computing system, code to implement the API in communication with the first application and each of the at least one second application (block 425); (2) autonomously generating, with the computing system, one or more communications paths between the first application and each of the at least one second application via the API (block 430); (3) autonomously provisioning, with the computing system, cloud computing space to at least one of the first application, one or more of the at least one second application, or the API (block 435); (4) autonomously provisioning, with the computing system, one or more microservices to at least one of the first application or one or more of the at least one second application, via the API (block 440); (5) autonomously generating, with the computing system, performance monitoring between the first application and each of the at least one second application via the API (block 445); (6) autonomously generating, with the computing system, secure access to the at least one of the first application, each of the at least one second application, or the API (block 450); and/or (7) autonomously generating, with the computing system, the API in communication with the first application and each of the at least one second application, based at least in part on the one or more first input parameters associated with the first application and based at least in part on the one or more second input parameters associated with each of the at least one second application or API (block 455); and/or the like.

According to some embodiments, the one or more microservices that are provisioned might include, without limitation, at least one of one or more management microservices, one or more security microservices, one or more streaming microservices, one or more bill payment microservices, or one or more customer microservices, and/or the like.

### Exemplary System and Hardware Implementation

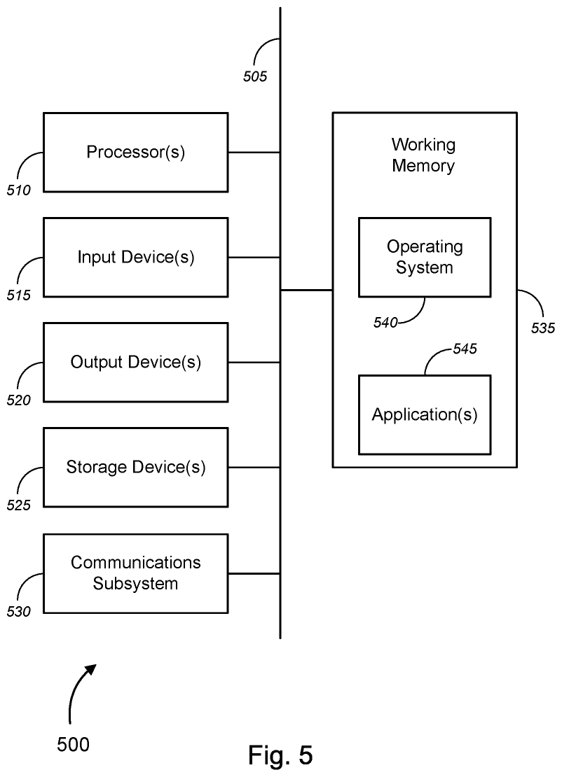

FIG. 5 is a block diagram illustrating an exemplary computer or system hardware architecture, in accordance with various embodiments. FIG. 5 provides a schematic illustration of one embodiment of a computer system 500 of the service provider system hardware that can perform the methods provided by various other embodiments, as described herein, and/or can perform the functions of computer or hardware system (i.e., computing systems 105a and 105b, user device(s) 115, computing devices 140 and 145, automation platform 200, API 305, etc.), as described above. It should be noted that FIG. 5 is meant only to provide a generalized illustration of various components, of which one or more (or none) of each may be utilized as appropriate. FIG. 5, therefore, broadly illustrates how individual system elements may be implemented in a relatively separated or relatively more integrated manner.

The computer or hardware system 500—which might represent an embodiment of the computer or hardware system (i.e., computing systems 105a and 105b, user device(s) 115, computing devices 140 and 145, automation platform 200, API 305, etc.), described above with respect to FIGS. 1-4—is shown comprising hardware elements that can be electrically coupled via a bus 505 (or may otherwise be in communication, as appropriate). The hardware elements may include one or more processors 510, including, without limitation, one or more general-purpose processors and/or one or more special-purpose processors (such as microprocessors, digital signal processing chips, graphics acceleration processors, and/or the like); one or more input devices 515, which can include, without limitation, a mouse, a keyboard, and/or the like; and one or more output devices 520, which can include, without limitation, a display device, a printer, and/or the like.

The computer or hardware system 500 may further include (and/or be in communication with) one or more storage devices 525, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer or hardware system 500 might also include a communications subsystem 530, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 530 may permit data to be exchanged with a network (such as the network described below, to name one example), with other computer or hardware systems, and/or with any other devices described herein. In many embodiments, the computer or hardware system 500 will further comprise a working memory 535, which can include a RAM or ROM device, as described above.

The computer or hardware system 500 also may comprise software elements, shown as being currently located within the working memory 535, including an operating system 540, device drivers, executable libraries, and/or other code, such as one or more application programs 545, which may comprise computer programs provided by various embodiments (including, without limitation, hypervisors, VMs, and the like), and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 525 described above. In some cases, the storage medium might be incorporated within a computer system, such as the system 500. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer or hardware system 500 and/or might take the form of source and/or installable code, which, upon compilation and/or installation on the computer or hardware system 500 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer or hardware system (such as the computer or hardware system 500) to perform methods in accordance with various embodiments of the invention. According to a set of embodiments, some or all of the procedures of such methods are performed by the computer or hardware system 500 in response to processor 510 executing one or more sequences of one or more instructions (which might be incorporated into the operating system 540 and/or other code, such as an application program 545) contained in the working memory 535. Such instructions may be read into the working memory 535 from another computer readable medium, such as one or more of the storage device(s) 525. Merely by way of example, execution of the sequences of instructions contained in the working memory 535 might cause the processor(s) 510 to perform one or more procedures of the methods described herein.

The terms “machine readable medium” and “computer readable medium,” as used herein, refer to any medium that participates in providing data that causes a machine to operate in a specific fashion. In an embodiment implemented using the computer or hardware system 500, various computer readable media might be involved in providing instructions/code to processor(s) 510 for execution and/or might be used to store and/or carry such instructions/code (e.g., as signals). In many implementations, a computer readable medium is a non-transitory, physical, and/or tangible storage medium. In some embodiments, a computer readable medium may take many forms, including, but not limited to, non-volatile media, volatile media, or the like. Non-volatile media includes, for example, optical and/or magnetic disks, such as the storage device(s) 525. Volatile media includes, without limitation, dynamic memory, such as the working memory 535. In some alternative embodiments, a computer readable medium may take the form of transmission media, which includes, without limitation, coaxial cables, copper wire, and fiber optics, including the wires that comprise the bus 505, as well as the various components of the communication subsystem 530 (and/or the media by which the communications subsystem 530 provides communication with other devices). In an alternative set of embodiments, transmission media can also take the form of waves (including without limitation radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 510 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer or hardware system 500. These signals, which might be in the form of electromagnetic signals, acoustic signals, optical signals, and/or the like, are all examples of carrier waves on which instructions can be encoded, in accordance with various embodiments of the invention.

The communications subsystem 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a storage device 525 either before or after execution by the processor(s) 510.

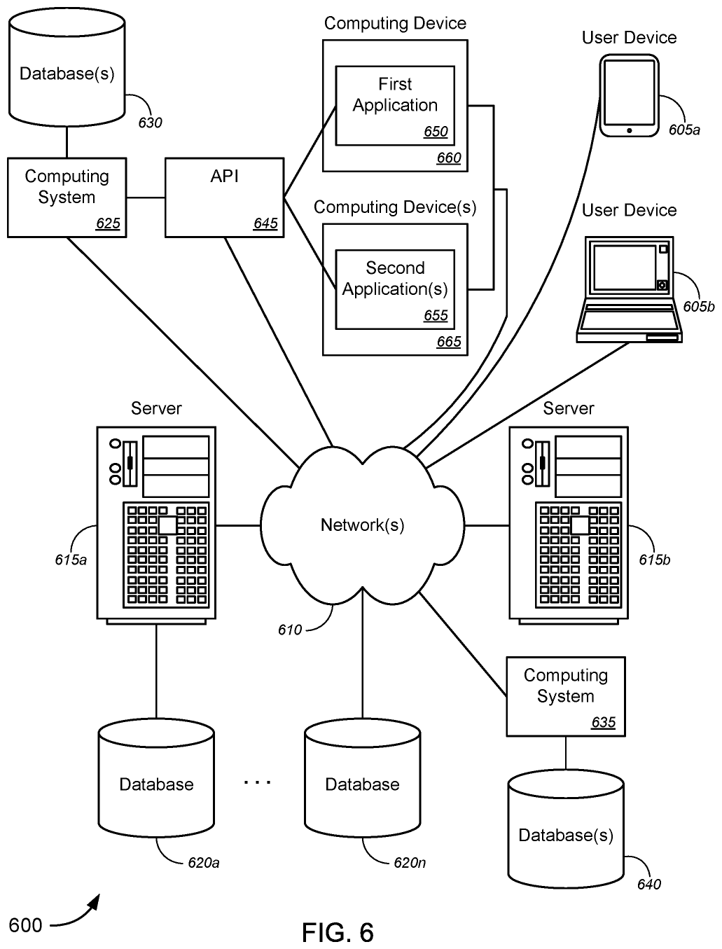

As noted above, a set of embodiments comprises methods and systems for implementing an automation platform for an application programming interface, and, more particularly, to methods, systems, and apparatuses for implementing an automation platform for designing, building, and executing application programming interfaces. FIG. 6 illustrates a schematic diagram of a system 600 that can be used in accordance with one set of embodiments. The system 600 can include one or more user computers, user devices, or customer devices 605. A user computer, user device, or customer device 605 can be a general purpose personal computer (including, merely by way of example, desktop computers, tablet computers, laptop computers, handheld computers, and the like, running any appropriate operating system, several of which are available from vendors such as Apple, Microsoft Corp., and the like), cloud computing devices, a server(s), and/or a workstation computer(s) running any of a variety of commercially-available UNIX™ or UNIX-like operating systems. A user computer, user device, or customer device 605 can also have any of a variety of applications, including one or more applications configured to perform methods provided by various embodiments (as described above, for example), as well as one or more office applications, database client and/or server applications, and/or web browser applications. Alternatively, a user computer, user device, or customer device 605 can be any other electronic device, such as a thin-client computer, Internet-enabled mobile telephone, and/or personal digital assistant, capable of communicating via a network (e.g., the network(s) 610 described below) and/or of displaying and navigating web pages or other types of electronic documents. Although the exemplary system 600 is shown with two user computers, user devices, or customer devices 605, any number of user computers, user devices, or customer devices can be supported.

Certain embodiments operate in a networked environment, which can include a network(s) 610. The network(s) 610 can be any type of network familiar to those skilled in the art that can support data communications using any of a variety of commercially-available (and/or free or proprietary) protocols, including, without limitation, TCP/IP, SNA, IPX™, AppleTalk™, and the like. Merely by way of example, the network(s) 610 (similar to network(s) 120 or 235 of FIGS. 1 and 2, or the like) can each include a local area network (“LAN”), including, without limitation, a fiber network, an Ethernet network, a Token-Ring™ network, and/or the like; a wide-area network (“WAN”); a wireless wide area network (“WWAN”); a virtual network, such as a virtual private network (“VPN”); the Internet; an intranet; an extranet; a public switched telephone network (“PSTN”); an infra-red network; a wireless network, including, without limitation, a network operating under any of the IEEE 802.11 suite of protocols, the Bluetooth™ protocol known in the art, and/or any other wireless protocol; and/or any combination of these and/or other networks. In a particular embodiment, the network might include an access network of the service provider (e.g., an Internet service provider (“ISP”)). In another embodiment, the network might include a core network of the service provider, and/or the Internet.

Embodiments can also include one or more server computers 615. Each of the server computers 615 may be configured with an operating system, including, without limitation, any of those discussed above, as well as any commercially (or freely) available server operating systems. Each of the servers 615 may also be running one or more applications, which can be configured to provide services to one or more clients 605 and/or other servers 615.

Merely by way of example, one of the servers 615 might be a data server, a web server, a cloud computing device(s), or the like, as described above. The data server might include (or be in communication with) a web server, which can be used, merely by way of example, to process requests for web pages or other electronic documents from user computers 605. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 605 to perform methods of the invention.

The server computers 615, in some embodiments, might include one or more application servers, which can be configured with one or more applications accessible by a client running on one or more of the client computers 605 and/or other servers 615. Merely by way of example, the server(s) 615 can be one or more general purpose computers capable of executing programs or scripts in response to the user computers 605 and/or other servers 615, including, without limitation, web applications (which might, in some cases, be configured to perform methods provided by various embodiments). Merely by way of example, a web application can be implemented as one or more scripts or programs written in any suitable programming language, such as Java™, C, C #™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer, user device, or customer device 605 and/or another server 615. In some embodiments, an application server can perform one or more of the processes for implementing an automation platform for an application programming interface, and, more particularly, to methods, systems, and apparatuses for implementing an automation platform for designing, building, and executing application programming interfaces, as described in detail above. Data provided by an application server may be formatted as one or more web pages (comprising HTML, JavaScript, etc., for example) and/or may be forwarded to a user computer 605 via a web server (as described above, for example). Similarly, a web server might receive web page requests and/or input data from a user computer 605 and/or forward the web page requests and/or input data to an application server. In some cases, a web server may be integrated with an application server.

In accordance with further embodiments, one or more servers 615 can function as a file server and/or can include one or more of the files (e.g., application code, data files, etc.) necessary to implement various disclosed methods, incorporated by an application running on a user computer 605 and/or another server 615. Alternatively, as those skilled in the art will appreciate, a file server can include all necessary files, allowing such an application to be invoked remotely by a user computer, user device, or customer device 605 and/or server 615.

It should be noted that the functions described with respect to various servers herein (e.g., application server, database server, web server, file server, etc.) can be performed by a single server and/or a plurality of specialized servers, depending on implementation-specific needs and parameters.

In certain embodiments, the system can include one or more databases 620a-620n (collectively, “databases 620”). The location of each of the databases 620 is discretionary: merely by way of example, a database 620a might reside on a storage medium local to (and/or resident in) a server 615a (and/or a user computer, user device, or customer device 605). Alternatively, a database 620n can be remote from any or all of the computers 605, 615, so long as it can be in communication (e.g., via the network 610) with one or more of these. In a particular set of embodiments, a database 620 can reside in a storage-area network (“SAN”) familiar to those skilled in the art. (Likewise, any necessary files for performing the functions attributed to the computers 605, 615 can be stored locally on the respective computer and/or remotely, as appropriate.) In one set of embodiments, the database 620 can be a relational database, such as an Oracle database, that is adapted to store, update, and retrieve data in response to SQL-formatted commands. The database might be controlled and/or maintained by a database server, as described above, for example.

According to some embodiments, system 600 might further comprise a computing system 625 and corresponding database(s) 630 (similar to computing system 105a and corresponding database(s) 110a of FIG. 1, or the like), a remote computing system 635 and corresponding database(s) 640 (similar to computing system 105b and corresponding database(s) 110b of FIG. 1, or the like).

In operation, the computing system 625 or computing system 635 (collectively, “computing system” or the like) might receive a request to set up an application programming interface (“API”) 645 in communication with a first application 650 and at least one second application 655. The first application 650 might run on a first computing device 660, while the at least one second application 655 might run on corresponding at least one second computing device 665. The computing system might communicatively couple with each of the first computing device 660 and each of the at least one second computing device 665, via network(s) 610. Alternatively, API 645 may be distributed throughout network 610, hosted on a device comprising the first application 650 and/or the second application(s) 655, and/or the like.

In some embodiments, the computing system 625 or 635 might further receive one or more first input parameters associated with the first application 650. Based in part on the one or more input parameters, the computing system 625 or 635 may then automatically or autonomously generate the API 645 in communication with the first application 650 and each of the at least one second application 655.

These and other functions of the system 600 (and its components) are described in greater detail above with respect to FIGS. 1-4.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
receiving, with a computing system, a request to set up an application programming interface (“API”) in communication with a first application and at least one second application;
receiving, with the computing system, one or more first input parameters associated with the first application; and
autonomously generating, with the computing system, the API in communication with the first application and each of the at least one second application, based at least in part on the one or more first input parameters associated with the first application.

2. The method of claim 1, wherein autonomously generating, with the computing system, the API in communication with the first application and each of the at least one second application comprises:
autonomously generating, with the computing system, code to implement the API in communication with the first application and each of the at least one second application.

3. The method of claim 1, wherein autonomously generating, with the computing system, the API in communication with the first application and each of the at least one second application comprises:
autonomously generating, with the computing system, one or more communications paths between the first application and each of the at least one second application via the API.

4. The method of claim 1, wherein autonomously generating, with the computing system, the API in communication with the first application and each of the at least one second application comprises:
autonomously provisioning, with the computing system, cloud computing space to at least one of the first application, one or more of the at least one second application, or the API.

5. The method of claim 1, wherein autonomously generating, with the computing system, the API in communication with the first application and each of the at least one second application comprises:
autonomously provisioning, with the computing system, one or more microservices to at least one of the first application or one or more of the at least one second application, via the API.

6. The method of claim 5, wherein the one or more microservices include at least one of one or more management microservices, one or more security microservices, one or more streaming microservices, one or more bill payment microservices, or one or more customer microservices.

7. The method of claim 1, wherein autonomously generating, with the computing system, the API in communication with the first application and each of the at least one second application comprises:
autonomously generating, with the computing system, performance monitoring between the first application and each of the at least one second application via the API.

8. The method of claim 1, wherein autonomously generating, with the computing system, the API in communication with the first application and each of the at least one second application comprises:
autonomously generating, with the computing system, secure access to the at least one of the first application, each of the at least one second application, or the API.

9. The method of claim 1, wherein the first application is associated with a customer of a service provider network and each of the at least one second application is associated with the service provider.

10. The method of claim 1, further comprising:
receiving, with the computing system, one or more second input parameters associated with each of the at least one second application; and
autonomously generating, with the computing system, the API in communication with the first application and each of the at least one second application, based at least in part on the one or more first input parameters associated with the first application and based at least in part on the one or more second input parameters associated with each of the at least one second application.

11. The method of claim 10, wherein the one or more first input parameters and the one or more second input parameters comprise at least one of one or more programming languages associated with the at least one of the first application, each of the at least one second application, or the API; one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API.

12. The method of claim 1, further comprising:
receiving, with the computing system, one or more third input parameters associated with the API; and
autonomously generating, with the computing system, the API in communication with the first application and each of the at least one second application, based at least in part on the one or more first input parameters associated with the first application and based at least in part on the one or more third input parameters associated with the API.

13. The method of claim 12, wherein the one or more third input parameters comprise at least one of one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API.

14. An apparatus, comprising:
at least one processor; and
a non-transitory computer readable medium communicatively coupled to the at least one processor, the non-transitory computer readable medium having stored thereon computer software comprising a set of instructions that, when executed by the at least one processor, causes the apparatus to:
receive a request to set up an application programming interface (“API”) in communication with a first application and at least one second application;
receive one or more first input parameters associated with the first application; and
autonomously generate the API in communication with the first application and each of the at least one second application, based at least in part on the one or more first input parameters associated with the first application.

15. The apparatus of claim 14, wherein the one or more first input parameters comprise at least one of one or more programming languages associated with the at least one of the first application, each of the at least one second application, or the API; one or more microservices associated with at least one of the first application, each of the at least one second application, or the API; cloud computing space associated with at least one of the first application, each of the at least one second application, or the API; performance metrics associated with at least one of the first application, each of the at least one second application, or the API; communication paths associated with at least one of the first application, each of the at least one second application, or the API; or security, authorization, or authentication associated with at least one of the first application, each of the at least one second application, or the API.

16. The apparatus of claim 14, wherein autonomously generating the API in communication with the first application and each of the at least one second application comprises:
autonomously generating code to implement the API in communication with the first application and each of the at least one second application.

17. The apparatus of claim 14, wherein autonomously generating the API in communication with the first application and each of the at least one second application comprises:
autonomously generating one or more communications paths between the first application and each of the at least one second application via the API.

18. The apparatus of claim 14, wherein autonomously generating the API in communication with the first application and each of the at least one second application comprises:
autonomously provisioning cloud computing space to at least one of the first application, one or more of the at least one second application, or the API.

19. The apparatus of claim 14, wherein autonomously generating the API in communication with the first application and each of the at least one second application comprises:
autonomously provisioning one or more microservices to at least one of the first application or one or more of the at least one second application, via the API.

20. A system, comprising:
a computing system, comprising:
at least one first processor; and
a first non-transitory computer readable medium communicatively coupled to the at least one first processor, the first non-transitory computer readable medium having stored thereon computer software comprising a first set of instructions that, when executed by the at least one first processor, causes the computing system to:
receive a request to set up an application programming interface (“API”) in communication with a first application and at least one second application;
receive one or more first input parameters associated with the first application; and
autonomously generate the API in communication with the first application and each of the at least one second application, based at least in part on the one or more first input parameters associated with the first application.
